(19) United States
(12) Patent Application Publication
(10) Pub. No.: US 2021/0257942 A1
(43) Pub. Date: Aug. 19, 2021

(54) BRAKE CIRCUIT DISCHARGE SYSTEM

(71) Applicant: NACHI-FUJIKOSHI CORP, Tokyo (JP)

(72) Inventor: RYUJI SAKAI, Toyama (JP)

(21) Appl. No.: 17/251,779

(22) PCT Filed: Jun. 12, 2019
(86) PCT No.: PCT/JP2019/023276

§ 371 Date: Dec. 11, 2020

(30) Foreign Application Priority Data
Jun. 12, 2018 (JP) 2018-112187

(51) Int. Cl. H02P 3/12; H02P 3/22

(52) U.S. Cl. CPC H02P 3/12; B25J 19/0004; H02P 3/22

(57) ABSTRACT

A brake circuit discharge system is disclosed that includes: a motor drive circuit configured to drive a motor; a brake drive circuit configured to drive a brake B to decelerate and stop the driving of the motor and to apply the brake when power is cut off; a control unit configured to control the operation of the motor drive circuit and the brake drive circuit; a capacitor connected to a power line of the brake drive circuit; a discharge resistor connected in parallel with the capacitor to the power line of the brake drive circuit, and configured to discharge electric charge accumulated in the capacitor; a discharge changeover switch connected in series to the discharge resistor; and a discharge instruction generation circuit connected to the discharge changeover switch, and configured to generate a switching instruction signal for opening and closing the discharge changeover switch.

### TECHNICAL FIELD

The present disclosure pertains to a brake circuit discharge system, and more particularly, to a brake circuit discharge system including a motive power source such as a motor, a brake that decelerates and stops driving the motive power source, and a control unit that controls the operation of the motive power source and the brake.

### BACKGROUND

In a conventional motor serving as a motive power source, a robot including a motor, or the like, a control panel is arranged separately, and power supplied to the motor is adjusted by a driver provided in the control panel to control the rotation of the motor. In recent years, however, motors and robots with built-in drivers have appeared.

When a motor with a built-in driver receives a command in form of a signal from a control panel or the like, the motor with the built-in driver adjusts power supplied to the motor to control the rotation speed of the motor or applies a brake. In particular, in order to decelerate and stop the motive power source, a method is used in which (1) the driver operates a drive system of a brake and applies the brake to stop rotation of the motor, (2) the driver adjusts the power supplied to the motor so that a force opposite to the rotation direction is applied to stop rotation of the motor, or (3) the driver reduces the power supplied to the motor to zero to stop rotation of the motor.

Patent Document 1 discloses, for example, a control device with a motive power cut-off function by operating an emergency stop switch in an emergency to cut off power of the drive system of a servomotor and operating the drive system of a brake to stop a robot arm of a multi-axis robot. With this configuration, the drive motor of the multi-axis robot can be safely and reliably stopped.

### RELATED DOCUMENTS

### Patent documents

Patent Document 1: JP 5552564A

### PROBLEMS TO BE SOLVED BY THE INVENTION

However, in a motor with a built-in driver, situations may occur (1) where the driver breaks down, or (2) where a communication line to effect communication is disconnected. In the case (1) above, there is a possibility that a brake is not applied and the motor continues to rotate. In case (2) above, the adjustment may not be performed well, and therefore there is a possibility that the power is supplied so that a force is applied in the rotation direction, or power is insufficiently supplied to effect a force in direction opposite to the rotation direction, which may render the motor uncontrollable. In situations such as those outlined above, when the motive power to the motor cannot be cut off, there is a possibility that electric power is continuously supplied. As a result, a dangerous state may be caused, such as no emergency stop of a robot, falling of an arm of the robot, or runaway conditions associated with the robot.

In order to solve such issues, when stopping a motor, it is recommended to decelerate and stop the motive power source as described above thereby cutting off the motive power of a motor with a built-in driver in the same manner as the motive power cutoff device disclosed in Patent Document 1, and thus completely reducing the power supply to the motor to zero. However, even if the motive power is cut off, unlike the motive power cut-off device disclosed in Patent Document 1, electric charge remains in the capacitor in the built-in driver. For this reason, electric power remains in the motor with a built-in driver for a short period of time, and the motor cannot be stopped reliably.

### SUMMARY

The present invention has been made in view of the above issues, and an object of the present invention is to provide a brake circuit discharge system capable of quickly and reliably stopping a motive power source.

In order to solve the above issues, a brake circuit discharge system according to the present invention includes: a motor drive circuit configured to drive a motor; a brake drive circuit configured to drive a brake to decelerate and stop the driving of the motor, and apply the brake at the time of power being cut off; a control unit configured to control the operation of the motor drive circuit and the brake drive circuit, and continuously send a brake release signal to the brake drive circuit; a capacitor that is connected to at least one of a power line of the brake drive circuit and a power line of the control unit; a discharge resistor that is connected to the power line to which the capacitor is connected and configured to discharge electric charge accumulated in the capacitor; a discharge changeover switch that is connected in series to the discharge resistor; and a discharge instruction generation circuit that is connected to the discharge changeover switch and configured to generate a switching instruction signal for opening and closing the discharge changeover switch.

### TECHNICAL EFFECTS

According to the brake circuit discharge system of the present invention, the electric charge accumulated in the circuit for driving the brake can be discharged, and the motive power source can be quickly and reliably stopped. The effects described herein are merely non-limiting examples, and any of the effects described in the art may also be applicable.

### BRIEF DESCRIPTION OF THE DRAWINGS

FIG. 1 is a block diagram showing a configuration of a brake circuit discharge system according to a first embodiment of the present invention.

FIG. 2 is a graph showing how the brake circuit discharge system according to the first embodiment of the present invention operates at the time of emergency stop.

FIG. 3 is a graph showing how the brake circuit discharge system according to the first embodiment of the present invention operates at the time of emergency stop.

FIG. 4 is a block diagram showing a configuration of a brake circuit discharge system of a conventional example.

FIG. 5 is a graph showing how the brake circuit discharge system of the conventional example operates at the time of emergency stop.

FIG. 6 is a block diagram showing a configuration of a brake circuit discharge system according to a second embodiment of the present invention.

FIG. 7 is a graph showing how the brake circuit discharge system according to the second embodiment of the present invention operates at the time of emergency stop.

FIG. 8 is a block diagram showing a configuration of a brake circuit discharge system according to a third embodiment of the present invention.

FIG. 9 is a block diagram showing a configuration of a brake circuit discharge system according to a fourth embodiment of the present invention.

FIG. 10 is a graph showing how the brake circuit discharge system according to the fourth embodiment of the present invention operates at the time of emergency stop.

FIG. 11 is a block diagram showing a configuration of a brake circuit discharge system according to a fifth embodiment of the present invention.

FIG. 12 is a graph showing how a brake circuit discharge system according to a sixth embodiment of the present invention operates at the time of emergency stop.

### DETAILED DESCRIPTION

Hereinafter, embodiments of the present invention will be described with reference to the drawings. The disclosure shows some representative examples to illustrate operation of the disclosed embodiments. The examples shown are merely illustrative are not intended to limit scope.

### First Embodiment

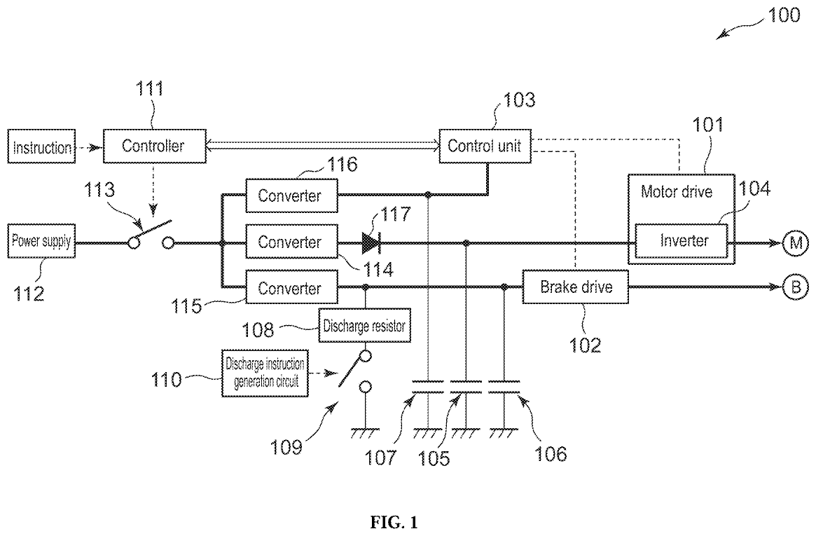

In FIG. 1, a brake circuit discharge system 100 according to a first embodiment of the present invention is described. FIG. 1 is a block diagram showing a configuration of a brake circuit discharge system 100 according to the present embodiment. FIG. 1 illustrates a simplified circuit configuration in each block. In FIG. 1, only blocks relating to the present invention are shown, and other blocks that may be present in the system are omitted for simplicity and ease of description.

As illustrated in FIG. 1, an actuator to which the brake circuit discharge system 100 is applied includes at least a motor M, a motor drive circuit 101 for controlling and driving the operation of the motor M, a brake B, a brake drive circuit 102 for controlling the operation of the brake B, and a control unit 103 for controlling the operation of the motor drive circuit 101 and the brake drive circuit 102. The motor drive circuit 101 includes an inverter 104 that converts direct current into alternating current. The motor drive circuit 101, the brake drive circuit 102, and the control unit 103 are collectively referred to as a driver unit. Each of the motor drive circuit 101, the brake drive circuit 102, and the control unit 103 has a capacitance capable of storing electric charge, such as a capacitor that is attached to stabilize the operation or a circuit pattern. These are referred to as a motor drive circuit capacitor 105, a brake drive circuit capacitor 106, and a control unit capacitor 107, respectively. The motor drive circuit capacitor 105, the brake drive circuit capacitor 106, and the control unit capacitor 107 are connected to power lines of the motor drive circuit 101, the brake drive circuit 102, and the control unit 103, respectively.

With respect to such an actuator, the brake circuit discharge system 100 according to the present embodiment includes a discharge resistor 108 that discharges the electric charge accumulated in the capacitors 105 to 107, a discharge changeover switch 109, and a discharge instruction generation circuit 110, which are inserted in parallel with the brake drive circuit capacitor 106. The discharge resistor 108 of the present embodiment is connected in parallel with the brake drive circuit capacitor 106 to the power line to which the brake drive circuit capacitor 106 is connected.

In FIG. 1, the present embodiment includes the following elements which are not essential elements of the present invention, but are generally included in an actuator. The brake circuit discharge system 100 according to the present embodiment includes: a driver for receiving a user instruction and controlling the operation of the actuator or controlling power supply according to the user instruction; a power cut-off switch 113 for opening and closing power supply from the power supply 112; converters 114, 115, and 116 for converting a power supply voltage into appropriate voltages suitable for the motor drive circuit 101, the brake drive circuit 102, and the control unit 103, respectively; and a diode portion 117 for preventing circuit failure due to backflow of regenerative power from the motor M to the converter 114 or the power supply 112. Ordinarily, a capacitor for stabilizing an output voltage and a capacitor for stabilizing an input voltage are connected to the converters 114, 115, and 116. However, in order to simplify the description, these capacitors are treated as being included in the motor drive circuit capacitor 105, the brake drive circuit capacitor 106, and the control unit capacitor 107, and will be separately described as necessary.

Components of the brake circuit discharge system 100 according to the present embodiment are described in more detail below.

The motor M converts power into mechanical energy, and the principle and configuration thereof are not particularly limited. The motor M is, for example, a so-called rotary motor such as a DC motor or an AC motor, or a so-called direct-acting motor using a solenoid coil.

The motor drive circuit 101 is not particularly limited as long as it has a function of adjusting a rotation amount, a rotation speed, and the like of the motor M based on a signal from the control unit 103. A method of adjusting the rotation amount, the rotation speed, and the like of the motor M may also be a method of changing a voltage or a current supplied to the motor M, or may also be a method of changing a cycle of a short pulse such as PWM. Furthermore, when it is not particularly necessary to adjust the rotation amount or the rotation speed of the motor M, the motor drive circuit 101 may not be used.

The brake B applies a load to the motor M or a movable part connected to the motor M to stop the rotation of the motor M to decelerate and stop the driving of the motor M. The principle and shape of the brake B are not particularly limited. As the brake B, for example, a brake using electromagnetic force such as an electromagnetic brake or a brake using frictional force such as a disc brake or a drum brake is used.

The brake drive circuit 102 determines whether or not to apply the brake B based on a signal from the control unit 103 to drive the brake. As a simple example, the brake drive circuit 102 may also be a switch for switching power supply to the brake B.

However, the brake B and the brake drive circuit 102 must be such that the brake B is applied at the time of power being cut off and the brake B is released at the time of power being supplied. In the case of a disc brake, for example, at the time of power being cut off, the disc brake holds the motor M or a movable part connected to the motor M so that the brake B is applied, and at the time of power being supplied, the disc brake is opened and the brake is released.

The control unit 103 may also be a module that controls the motor M or the brake B by sending a signal to the motor drive circuit 101 or the brake drive circuit 102 based on a signal received from a controller 111. The principle and the configuration thereof are not particularly limited. Furthermore, the controller 111 may also include the function of the control unit 103, or may also be included in the motor drive circuit 101 and/or the brake drive circuit 102. However, it is desirable that the signal from the control unit 103 to the brake drive circuit 102 is such that the brake B is applied when the power supply to the control unit 103 is cut off.

As an example, the discharge resistor 108 is connected in parallel with the brake drive circuit capacitor 106 between the brake drive circuit capacitor 106 and the converter 115. The discharge resistor 108 is a resistor often used in an electric circuit, and the shape and the material thereof are not particularly limited as long as it limits a current according to an applied voltage, causes a voltage drop, and consumes energy according to the current and the voltage drop. However, in order to discharge the electric charge accumulated in the brake drive circuit capacitor 106, which is the purpose of the discharge resistor 108, the discharge resistor 108 is preferably a resistor having a resistance that is as small as possible, and is preferably 1Ω or more and 1,000Ω or less. Specifically, the resistance value may also be designed so that the product of the resistance of discharge resistor 108 and the capacitance of brake driving capacitor 106 is equal to or less than the time required to complete the discharge. When the time required to complete discharge is 1 millisecond and the capacitance of the brake driving capacitor 106 is 10 microfarad (μF), for example, the resistance value of the discharge resistor 108 is 10Ω or less. Also, because a large current flows instantaneously at the time of charge discharge, the discharge resistance 108 preferably has an inrush resistance. Although a detailed description is omitted in this specification, the discharge resistor 108 is not limited to a resistor, and may also be an element that consumes power and converts the power into other energy. For example an LED may also be used to convert power into light energy.

The discharge changeover switch 109 is connected in series between the discharge resistor 108 and the ground. The shape, material, and the principle of the discharge changeover switch 109 are not particularly limited as long as the discharge changeover switch 109 determines whether or not a closed circuit is formed by the discharge changeover switch discharge resistor 108 and the brake drive circuit capacitor 106. Examples of the discharge changeover switch 109 include a semiconductor switch such as a transistor and an electromagnetic relay. In order to discharge the electric charge accumulated in the brake drive circuit capacitor 106 as quickly as possible at a necessary timing, the discharge changeover switch 109 is preferably a semiconductor switch having a high response speed from the reception of discharge changeover instruction to the switch switching. Although drive circuits for switching are not shown, it is assumed that a drive circuit is included in discharge changeover switch 109 as appropriate.

The discharge instruction generation circuit 110 has an output side connected to the discharge changeover switch 109, and generates a switching instruction signal for opening and closing the discharge changeover switch 109. The discharge instruction generation circuit 110 determines the timing for switching the discharge changeover switch 109 between the open and closed state, and also causes the switch to perform switching. The shape, material, and principle of the discharge instruction generation circuit 110 are not particularly limited. The discharge instruction generation circuit 110 may be realized by, for example, a logic circuit using a logic IC or diodes, a comparison circuit using a comparator, or software processing included in the above-described controller, the control unit, an external microcomputer, or the like. The input side of the discharge instruction generation circuit 110 may be connected to a functional unit and/or functional element that reacts after the user issues an instruction (emergency stop or stop command) to stop the motive power source. In FIG. 1, for example, the input side of the discharge instruction generation circuit 110 can be connected to any of the instruction, the controller 111, the input side of the motive power cut-off switch 113, the auxiliary contact of the motive power cut-off switch 113, the output side of the motive power cut-off switch 113, and the input side of the control unit 103 or the brake drive circuit 102.

The controller 111 controls the units based on an instruction from a user. In general, the controller 111 has a role of opening and closing the power cut-off switch 113 and converting an instruction from a user into an instruction value to the control unit 103. The controller 111 is connected to the control unit 103 and the power cut-off switch 113. The control signal from the controller 111 to the control unit 103 and the power cut-off switch 113 may also be any signal such as a logic signal or a communication signal. In the present embodiment, for the sake of explanation, dotted lines indicate logic signals and block arrows indicate communication signals. Also, thicker lines are used to indicate power lines.

The power cut-off switch 113 receives a signal from the controller 111, and switches power supplied from the power supply 112 to the subsequent stage, The power is switched on or off by the power cut-off switch 113 in accordance with the signal from the controller 111. In general, a switch having a mechanical contact such as a circuit breaker, a relay, an electromagnetic switch, or a magnet switch, or a semiconductor switch such as a FET or an IGBT can be used as the power cut-off switch 113. However, the power cut-off switch 113 is not limited to such a switch and may also be any switch as long as it can be switched. For the sake of description, the power cut-off switch 113 is configured to receive a signal from the controller 111 to perform switching. However, the power cut-off switch 113 may also be directly operated by a user or may also be operated by a signal from the control unit 103. Although a drive circuit necessary for switching is not shown, it is assumed that the drive circuit is included in the power cut-off switch 113. Also, when implemented as an electromagnetic switch or the like, it is desirable that the switch includes a component called an auxiliary contact whose open and closed state changes in accordance with the state of the switch.

The converters 114 to 116 are modules for converting an input voltage into an output voltage that is freely selected, and also have a function of converting an alternating current into a direct current. The converters 114 to 116 of the present embodiment are used to convert a voltage supplied from the power supply 112 into a voltage suitable for each of the motor drive circuit 101, the brake drive circuit 102, and the control unit 103. The converters 114 to 116 are also referred to as a motor drive circuit converter 114 that is connected in series to the power line of the motor drive circuit 101, a brake drive circuit converter 115 that is connected in series to the power line of the brake drive circuit 102, and a control unit converter 116 that is connected in series to the power line of the control unit 103, respectively. If the voltage of the power supply 112 matches the rated input voltage of each unit, the converters 114 to 116 are not necessary. Also, the motor drive circuit 101, the brake drive circuit 102, and the control unit 103 having the same rated input voltage may also be integrated. Furthermore, a multistage connection configuration may be employed in which the output of the motor drive circuit converter 114 is used as the input of the brake drive circuit converter 115.

The diode portion 117 is a rectifying element for protecting the power supply 112 and the converter 114 from being damaged by backflow of regenerative power generated in the motor M when the motor M is stopped or decelerated. If the regenerative power is small enough not to cause a problem, then diode portion 117 may be omitted.

Next, the timing at which the discharge changeover switch switches between the open and closed states will be described below.

An object of the present invention is to quickly and reliably drive the brake of the actuator. For this purpose, it is necessary for the discharge instruction generation circuit 110 to output a discharge instruction to the discharge changeover switch 109 in accordance with the timing at which the brake B is to be driven. As examples for driving the brake B, first, there is a controlled stop that is performed in a normal state. In the present embodiment, after receiving an instruction to apply the brake B from a user, the controller 111 sends a brake start instruction to the control unit 103 to drive the brake B. Then, the control unit 103 controls the brake drive circuit 102 to apply the brake B. In such a case, any one of an instruction from the user to the controller 111, an instruction from the controller 111 to the control unit 103, and an instruction from the control unit 103 to the brake drive circuit 102 may be used as an input to the discharge instruction generation circuit 110. This is because an instruction is sent to each unit from the time when the brake B is about to be applied to the time when the brake B is applied, so that it is sufficient to monitor the instruction in order to know the timing when the brake B is to be applied.

Next, an emergency stop performed in an emergency will be described. The emergency stop is an operation of stopping the actuator in preference to all of other components in a case where the actuator becomes uncontrollable or may cause harm to a person. The operation of the emergency stop is basically the same as the operation of the controlled stop described above. The major difference between the emergency stop and the controlled stop is that the controller 111 sends a power cut-off instruction to the power cut-off switch 113 to cut off the power supply 112. It should be noted that the brake circuit discharge system 100 is also effective and may be applicable to products in which the power supply 112 is cut off and the control is stopped at the same time. In the present embodiment, a case will be described in which control is also stopped at the time of an emergency stop.

The purpose of cutting off the power supply 112 is to apply the brake B by stopping the power supply to the motor M so that the motor M cannot operate and by stopping the power supply to the brake drive circuit 102 so that the brake release state cannot be maintained, even when any one of the elements related to the brake operation, such as the control unit 103 and the brake drive circuit 102, has failed.

However, even if the power supply is stopped, if the electric charge is accumulated in the brake drive circuit capacitor 106, as described above, the electric charge accumulated in the brake drive circuit capacitor 106 may be supplied to the brake drive circuit 102, and the brake release state can be maintained. Therefore, if the discharge changeover switch 109 is immediately closed to discharge the electric charge accumulated in the brake drive circuit capacitor 106, the power for operating the brake drive circuit 102 can be quickly dissipated, and the time until the brake B is applied can be shortened.

That is to say, in addition to a case where control is stopped, a power cut-off instruction from the controller 111 to the power cut-off switch 113 or a signal triggered by a voltage drop on the output side of the power cut-off switch 113 may be used as an input to the discharge instruction generation circuit 110. However, the output voltage of the power cut-off switch 113 does not drop instantaneously even after the power cut-off because electric charge is accumulated in the capacitance component of the input stage or the like of the converter 114. Accordingly, in the case where the output voltage drop of the power cut-off switch 113 is used as a trigger, it takes time to reach the threshold voltage at which it is determined that the voltage has dropped. In other words, there is the problem that a delay occurs with respect to a timing at which an emergency stop is actually desired, and there is the problem that a voltage drop does not occur if the power cut-off switch 113 is defective. Accordingly, it is desirable to use a power cut-off instruction of the controller 111 or a stop instruction from a user.

In consideration of the case where the power cut-off switch 113 fails, even when the discharge changeover switch 109 is closed, the discharge resistor 108 may consume only the power supplied from the converter 115, and a state in which sufficient power is supplied for brake release may occur. In such a case, it is desirable to add a switch for cutting off the power to the brake B separately from the power cut-off switch 113 so that the power can be cut off, for example, by stopping the operation of the converter 115 using the output of the discharge instruction generation circuit 110. In the above description, the power cut-off is described as the difference between the controlled stop and the emergency stop. However, it is not always necessary to distinguish between the controlled stop and the emergency stop, and the power cut-off may be performed even when control is stopped.

Therefore, the brake circuit discharge system will be described below by illustrating the operation at the time of emergency stop in the present embodiment as an example.

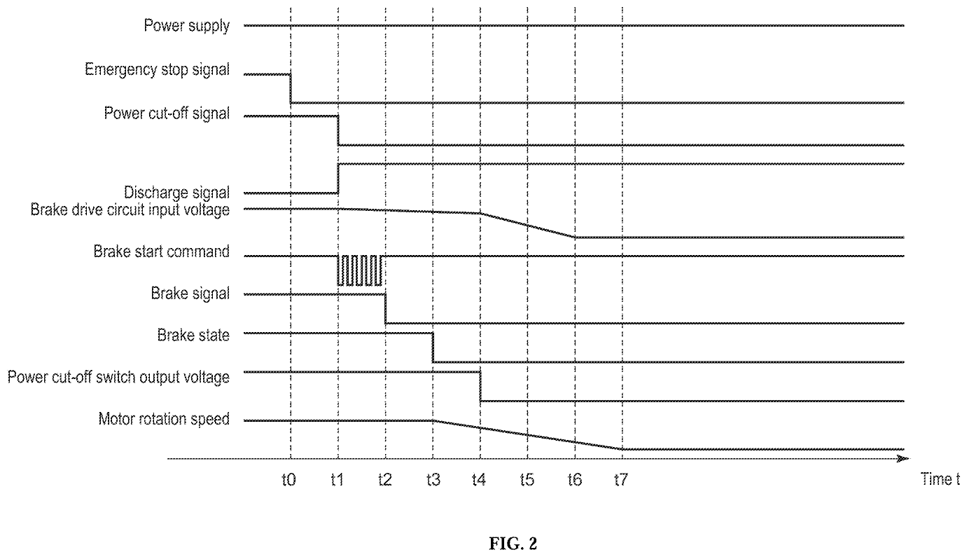

FIG. 2 shows a state at each point after time t from the generation of an emergency stop signal in a normal state in which no failure occurs. FIG. 2 is a graph showing how the brake circuit discharge system 100 according to the present embodiment operates at the time of emergency stop. However, because the amount of delay due to the communication time and the operation time varies depending on the components and the control method used, the timing may not be as described in the present specification and slight deviations may occur. However, the effect of the present embodiment is not impaired by this deviation.

First, an emergency stop signal is generated at time t0. Then, at time t1, the controller 111, which has received the emergency stop signal, sends a discharge signal to the discharge instruction generation circuit 110, a brake start command to the control unit 103, and a power cut-off signal to the power cut-off switch 113. At this time, the discharge instruction generation circuit 110, which has received the discharge signal, closes the discharge changeover switch 109 so that a current flows through the discharge resistor 108. Then, the input voltage of the brake drive circuit 102 starts to drop, but this voltage drop is gentle because power is supplied from the brake drive circuit converter. Although, the power cut-off signal and the discharge signal have been shown as logic signals, and the brake start command has been shown as a communication signal, as described above, the effect of the present invention is not impaired by the type of signal.

At time t2, the control unit, which has received the brake start command, sends a brake signal to the brake drive circuit 102 to apply the brake B.

Furthermore, at time t3, the brake drive circuit 102, which has received the brake signal, terminates the brake release state, and the brake B is applied and the motor M starts to decelerate.

Then, at time t4, the power cut-off switch 113, which has received the power cut-off signal, cuts off the power supply to the converters 114 to 116. Then, the power supply from the brake drive circuit converter 115, which supplies the energy consumed by the discharge resistor 108, is stopped, and therefore the electric charge accumulated in the brake drive circuit capacitor 106 is consumed by the discharge resistor 108. As a result, the input voltage of the brake drive circuit 102 drops rapidly.

At time t5, the input voltage of the brake drive circuit 102 drops to such an extent that the brake release state cannot be maintained. Note, however, that the brake was applied when the brake (release) state was terminated at time t3, and therefore the logical state does not change in particular.

At time t6, the electric charge of the capacitor of the brake drive circuit is completely discharged, and the input voltage of the brake drive circuit 102 becomes zero, but, as outlined above, the logical state does not change in particular.

Finally, at time t7, the rotational speed of the motor M becomes zero, and the actuator is completely stopped.

In this example, application of the brake B is initiated by the brake start signal. However, the brake may be actually applied when the input voltage of the brake drive circuit 102 becomes lower than the voltage required to release the brake B, which may depend on (a) the delay for the brake start signal to reach the brake drive circuit 102, (b) the rate of voltage drop of the input voltage of the brake drive circuit 102, and (c) the delay of the power cut-off switch 109. Nevertheless, even in the above situations, the present invention is effective.

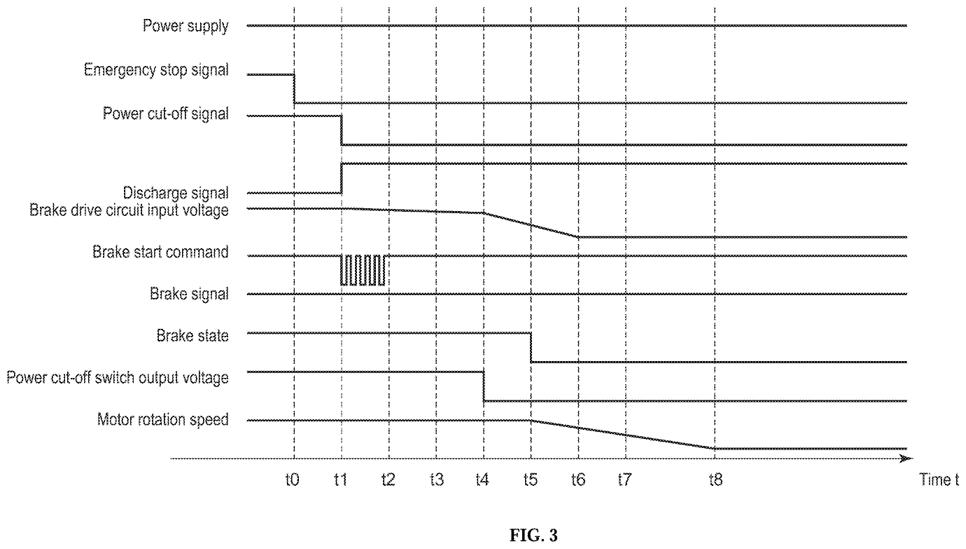

Next, in order to explain a further effect of the present invention, a state in which the control unit 103 in the present embodiment has failed will be described. FIG. 3 is a graph showing how the brake circuit discharge system 100 according to the present embodiment operates at the time of emergency stop. FIG. 3 shows a state at each point after time t from the generation of the emergency stop signal.

First, an emergency stop signal is generated at time t0. Then, at time t1, the controller 111, which has received the emergency stop signal, sends a brake start command to the control unit 103, a power cut-off signal to the power cut-off switch 113, and a discharge signal to the discharge instruction generation circuit 110. At this time, the discharge instruction generation circuit 110, which has received the discharge signal, closes the discharge changeover switch 109 so that a current flows through the discharge resistor 108. Then, the input voltage of the brake drive circuit 102 starts to drop, but this voltage drop is gentle because power is supplied from the brake drive circuit converter 115.

Next, at time t2, the control unit 103, which has received the brake start command, is supposed to send a brake signal to the brake drive circuit 102 to apply the brake B, but the brake signal is not sent because the control unit 103 fails.

That is to say, at time t3, because the brake drive circuit 102 receives no brake signal, the brake release state continues, the brake B is not applied, and the motor M does not decelerate.

On the other hand, at time t4, the power cut-off switch 113, which has received the power cut-off signal, cuts off the power supply to the converters 114 to 116. Then, the power supply from the brake drive circuit converter 115, which supplies the energy consumed by the discharge resistor 108, is stopped, and therefore the electric charge accumulated in the brake drive circuit capacitor 106 is consumed by the discharge resistor 108. As a result, the input voltage of the brake drive circuit 102 starts to drop rapidly.

Furthermore, at time t5, the brake drive circuit input voltage drops to such an extent that the brake release state cannot be maintained, whereby the brake release is cancelled, the brake B is applied, and the motor M starts to decelerate.

At time t6, the electric charge of the brake drive circuit capacitor 106 is completely discharged and the input voltage of the brake drive circuit 102 becomes zero, but the logical brake state does not change in particular.

Finally, at time t8 after time t7, the rotational speed of the motor becomes zero, and the actuator is completely stopped.

As described above, according to the brake circuit discharge system 100, the actuator can be completely stopped although it takes a longer time than in the normal state.

### Conventional Example

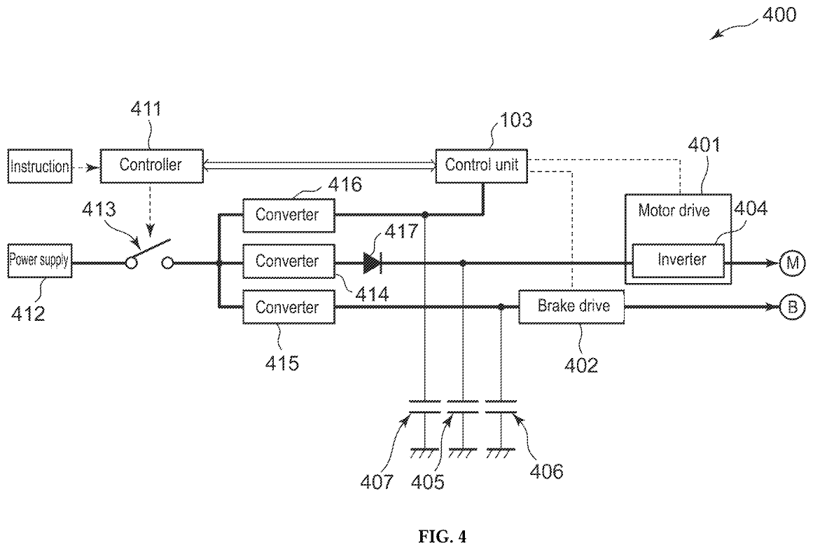

In order to make the effects of the present invention easier to understand, a conventional example will be described below. FIG. 4 is a block diagram showing a configuration of a brake circuit discharge system of a conventional example. FIG. 4 illustrates a simplified circuit configuration in each block.

Similarly to the brake circuit discharge system 100 of the first embodiment, an actuator to which a brake circuit discharge system 400 is applied includes the motor M, a motor drive circuit 401, the brake B, a brake drive circuit 402, and a control unit 403. The motor drive circuit 401 includes an inverter 404. A motor drive circuit capacitor 405, a brake drive circuit capacitor 406, and a control unit capacitor 407 are attached to the motor drive circuit 401, the brake drive circuit 402, and the control unit 403, respectively.

The brake circuit discharge system 400 according to the conventional example includes: a controller 411; a power cut-off switch 413 for opening and closing the power supply from the power supply 412; converters 414, 415, and 416 for converting the power supply voltage into voltages suitable for the motor drive circuit 401, the brake drive circuit 402, and the control unit 403, respectively; and a diode portion 417 for preventing circuit failure due to backflow of regenerative power from the motor M to the converter 414 and the power supply 412.

That is to say, the brake circuit discharge system 400 of the conventional example is a system in which the discharge resistor 108, the discharge changeover switch 109, and the discharge instruction generation circuit 110 are removed from the brake circuit discharge system 100 of the first embodiment.

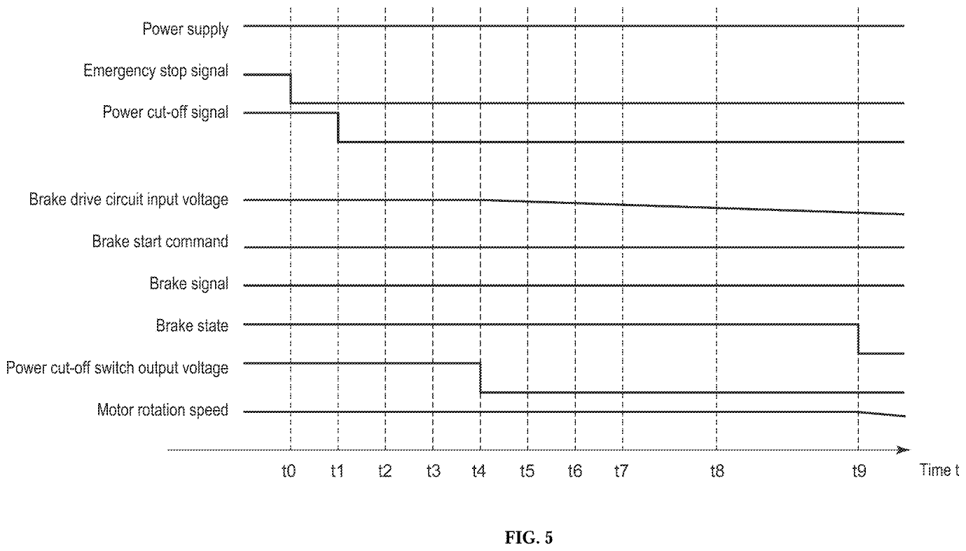

Next, a state in which the control unit 403 of the conventional example has failed will be described. FIG. 5 is a graph showing how the brake circuit discharge system 400 according to the conventional example operates at the time of an emergency stop. FIG. 5 shows a state at each point after time t0 from the generation of the emergency stop signal.

First, an emergency stop signal is generated at time t0. Then, at time t1, the controller 411, which has received the emergency stop signal, sends a power cut-off signal to the power cut-off switch 413 and a brake start command to the control unit 403. Here, the brake circuit discharge system 400 of the conventional example includes no discharge resistor. Accordingly, a phenomenon in which the input voltage of the brake drive circuit 402 drops due to a current flowing through the discharge resistor does not occur.

Next, at time t2, the control unit 403, which has received the brake start command, is supposed to send a brake signal to the brake drive circuit 402 to apply the brake, but the brake signal is not sent because the control unit 403 fails.

That is to say, even at time t3, because the brake drive circuit 402 receives no brake signal, the brake release state continues, the brake B is not applied, and the motor M does not decelerate.

Then, at time t4, the power cut-off switch 413, which has received the power cut-off signal, cuts off the power supply to the converters 414 to 416. Then, the power supply from the brake drive circuit converter 415 is stopped, but the electric charge accumulated in the brake drive circuit capacitor 406 is not consumed by the discharge resistor. Accordingly, the input voltage of the brake drive circuit 402 does not drop rapidly. However, although not described in the first embodiment, the input voltage of the brake drive circuit 402 may slowly drop due to power consumption of the brake drive circuit 402 and the natural discharge of the capacitor 406. Such a case will be described below.

Even as time passes from time t5 to time t8, the input voltage of the brake drive circuit 402 does not drop to such an extent that the brake release state cannot be maintained. Accordingly, the brake release state continues and the state does not change in particular. Because the brake B is not applied, the rotation speed of the motor is not reduced by the brake B. However, because the power supply to the motor drive circuit 402 is also cut off by the power cut-off switch 413 at time t4, the rotational speed of the motor M cannot be maintained, and the motor M is slowly decelerated. However, such a phenomenon is affected by the electric discharge accumulated in the motor drive circuit capacitor 405, the friction of the motor M, and the like. Therefore, it is assumed that such a phenomenon does not occur because the description thereof becomes complicated and the effect of the conventional example becomes difficult to understand.

At time t9, the input voltage of the brake drive circuit 402 drops to such an extent that the brake release state cannot be maintained. Accordingly, the brake release state terminates, the brake B is applied, and the motor M starts to decelerate.

As described above, it will be appreciated that, when the first embodiment is compared with the conventional example, the brake circuit discharge system 100 of the first embodiment can apply the brake B more quickly.

### Second Embodiment

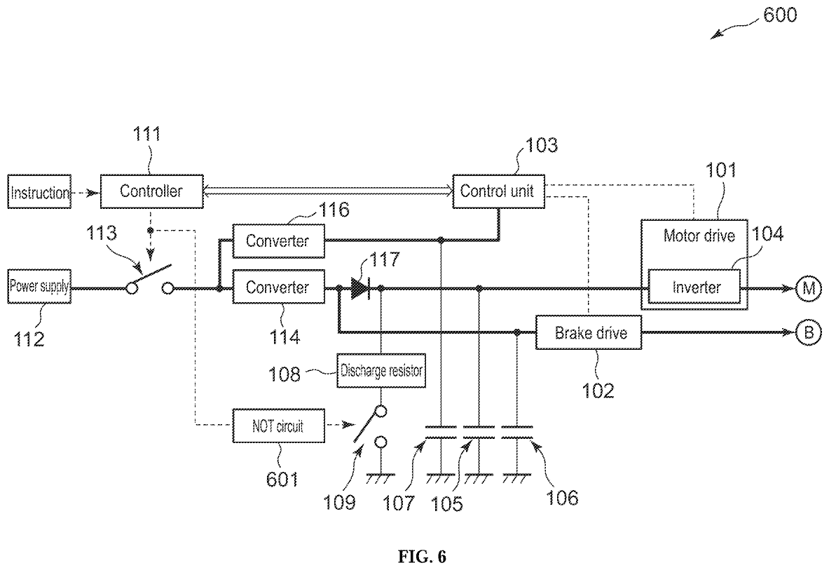

FIG. 6 is a block diagram showing a configuration of a brake circuit discharge system 600 according to a second embodiment of the present invention. FIG. 6 illustrates a simplified circuit configuration in each block of the brake circuit discharge system 600. In FIG. 6, only the blocks relating to the present embodiment are shown, and other blocks necessary for each system are omitted.

A first difference between the present embodiment and the first embodiment is that a signal from the controller 111 to the power cut-off switch 113 is used as an example of the discharge instruction generation circuit. A second difference between the present embodiment and the first embodiment is that the motor drive circuit converter 114 is also used as the brake drive circuit converter 115. Hereinafter, the motor drive circuit converter 114 and the brake drive circuit converter 115 are collectively referred to as a drive circuit converter 114, and the motor drive circuit input voltage and the brake drive circuit input voltage are collectively referred to as a drive circuit input voltage.

The discharge instruction generation circuit in the present embodiment is a NOT circuit 601. The NOT circuit 601 includes a circuit for inverting the logic of an input signal and a circuit for operating the discharge changeover switch 109. The signal line that is connected from the controller 111 to the power cut-off switch 113 is also connected to the input of the NOT circuit 601, and the output of the NOT circuit 601 is connected to the signal input terminal of the discharge changeover switch 109. Here, the power cut-off switch 113 is closed when the input is at a high level, and is open when the input is at a low level. The discharge changeover switch 109 is also closed when the input is a high level, and is open when the input is at a low level. That is to say, the power cut-off switch 113 and the discharge changeover switch 109 have the same logic. This is to realize an operation in which power is supplied but discharge is not performed while the actuator operates, and power is not supplied but discharge is performed while the actuator stops. Accordingly, if the logics of the power cut-off switch 113 and the discharge changeover switch 109 are opposite to each other, a circuit for inverting the logic in the NOT circuit 601 is unnecessary. In the present embodiment, the signal line that is connected from the controller 111 to the power cut-off switch 113 is used. However, when the power cut-off switch is a magnetic switch, the input of the NOT circuit 601 may also be connected to the auxiliary contact. However, in this case, because there is a possibility that the auxiliary contact does not operate when the magnetic switch fails, it is preferable to directly use the signal from the controller 111 as in this embodiment.

The converter 114 in the present embodiment supplies power to the motor M and the brake B. This is based on the assumption that the rated input voltages of the motor drive circuit 101 and the brake drive circuit 102 are equal to each other as described above to a degree that is acceptable. In this configuration, it should be noted that the discharge resistor 108 and the discharge changeover switch 108 are required to be connected to the motor M or the brake B side of the diode portion 117. This is because, if the discharge resistor 108 and the discharge changeover switch 108 are connected to the converter 114 side of the diode portion 117, the diode portion 117 prevents the electric charge accumulated in the motor drive circuit capacitor 105 or the brake drive circuit capacitor 106 from flowing into the discharge resistor 108 due to the rectifying action of the diode portion 117, and the effect of the present embodiment is not obtained.

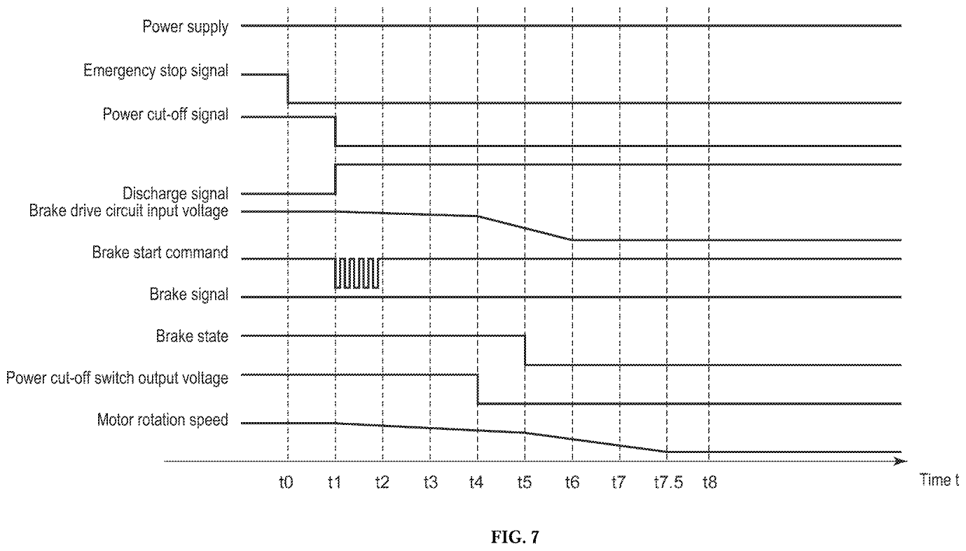

Next, with reference to FIG. 7, a description will be given of a state at each point after time t0 from the generation of the emergency stop signal in a state where the control unit 103 of the present embodiment has failed. FIG. 7 is a graph showing how the brake circuit discharge system 600 according to the present embodiment operates at the time of emergency stop.

First, an emergency stop signal is generated at time t0. Then, at time t1, the controller 111, which has received the emergency stop signal, sends a power cut-off signal to the power cut-off switch 113, a discharge signal to the discharge instruction generation circuit, and a brake start command to the control unit 103. At this time, the discharge instruction generation circuit, which has received the discharge signal, closes the discharge changeover switch 109 so that a current flows through the discharge resistor 108. Then, the input voltage of the motor drive circuit 101 starts to drop. However, because power is supplied from the motor drive circuit converter 114, this voltage drop is gentle. Here, due to the voltage drop of the input voltage of the motor drive circuit 101, the power that is supplied to the motor M decreases and the rotation speed cannot be maintained, and thus the motor M starts to decelerate.

Next, at time t2, the control unit 103, which has received the brake start command, is supposed to send a brake signal to the brake drive circuit 102 to apply the brake B, but the brake signal is not sent because the control unit 103 fails.

That is to say, at time t3, because the brake drive circuit 102 receives no brake signal, the brake release state continues, the brake B is not applied, and the motor M does not decelerate.

On the other hand, at time t4, the power cut-off switch 113, which has received the power cut-off signal, cuts off the power supply to the converters 114 and 116. Then, the power supply from the drive circuit converter 114, which has been supplying the energy consumed by the discharge resistor 108, is stopped. Accordingly, the electric charge accumulated in the motor drive circuit capacitor 105 and the brake drive circuit capacitor 106 is consumed by the discharge resistor 108. As a result, the drive circuit input voltage starts to drop rapidly.

Furthermore, at time t5, the drive circuit input voltage drops to such an extent that the brake release state cannot be maintained. Accordingly, the brake release is terminated, the brake B is applied, and the motor M further decelerates.

At time t6, the electric charge of the brake drive circuit capacitor 106 is completely discharged and the brake drive circuit input voltage becomes zero, but the logical brake state does not change in particular.

Finally, at time t7.5, the rotational speed of the motor becomes zero, and the actuator is completely stopped.

As described above, when the brake circuit discharge system 600 according to the present embodiment is compared with the brake circuit discharge system 100 according to the first embodiment, the rotation of the motor M can be suppressed by the voltage drop of the drive circuit input voltage. Therefore, the brake circuit discharge system 600 can apply the brake B faster than the brake circuit discharge system 100.

### Third Embodiment

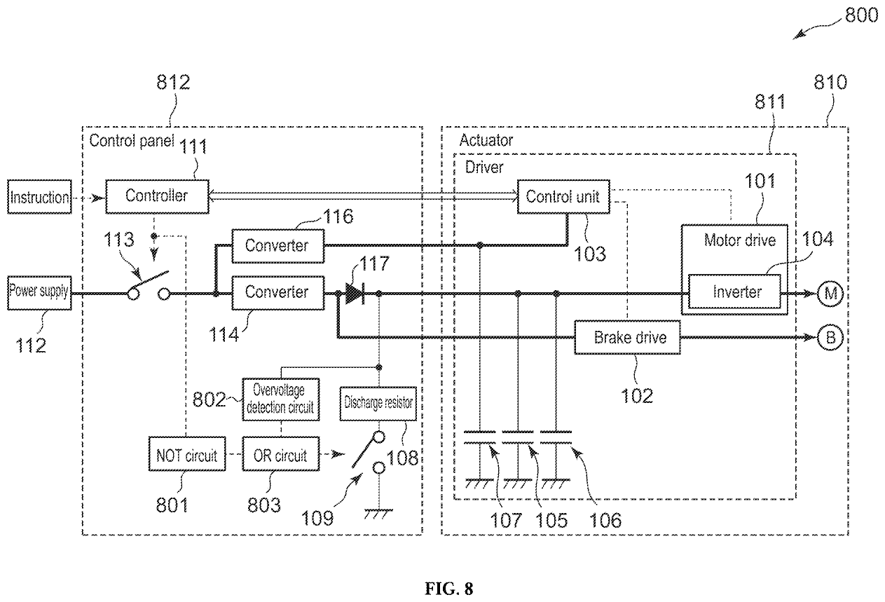

FIG. 8 is a block diagram showing a configuration of a brake circuit discharge system 800 according to a third embodiment of the present invention. FIG. 8 illustrates a simplified circuit configuration in each block of the brake circuit discharge system 800. In FIG. 8, only blocks relating to the present embodiment are shown, and other blocks that may be present are omitted for simplicity and ease of description.

In the brake circuit discharge system 800 according to the present embodiment, like the brake circuit discharge system 600 according to the second embodiment, a NOT circuit 801 is connected to a signal line that is branched from a signal line that is connected from the controller 111 to the power cut-off switch 113. The present embodiment is different from the second embodiment in that an overvoltage detection circuit 802 is added, and an OR circuit 803 that outputs a logical sum of an output signal of the overvoltage detection circuit 802 and the above-described switching instruction signal (discharge signal instruction) to the discharge changeover switch 109 is added. Here, a circuit including the NOT circuit 801, the overvoltage detection circuit 802, and the OR circuit 803 is a discharge instruction generation circuit in the present embodiment. The overvoltage detection circuit 802 is connected between the diode portion 117 and the motor drive circuit 101. That is to say, the overvoltage detection circuit 802 is connected between the power line of the motor drive circuit 101 to which the motor drive circuit capacitor 105 is connected, and the discharge resistor 108. The OR circuit 803 is connected to the output of the NOT circuit 801 and the output of the overvoltage detection circuit 802.

In the present embodiment, the actuator 810 and the control panel 812 including elements other than the actuator 810 are housed in separate housings, and signal lines and power lines are connected by cables between the housings. The actuator 810 includes a driver 811 including the motor drive circuit 101, the brake drive circuit 102, the control unit 103, and the capacitors 105 to 107. The brake circuit discharge system 800 according to the present embodiment can be applied to, for example, a robot incorporating the actuator 810 including the driver 811.

The overvoltage detection circuit 802 only needs to have a function of generating an output for closing the discharge changeover switch 109 when a voltage of a connection portion between the diode portion 117 and the motor drive circuit 101 exceeds a certain threshold. The principle and the configuration of the overvoltage detection circuit 802 are not particularly limited. The overvoltage detection circuit 802 may also be, for example, a comparison circuit using a comparator and a reference voltage, or a circuit using a Zener diode. Furthermore, outputs obtained by converting voltage values into digital values by an A/D converter may also be taken into a microcomputer or the like, and the outputs may also be compared on software.

The overvoltage detection circuit 802 detects an overvoltage generated by regenerative power that is generated when the motor M is decelerated by the brake B or when the motor M is accelerated by external force. When such an overvoltage is detected, the discharge changeover switch 109 is closed to consume the regenerative power by the discharge resistor 108, thereby suppressing the overvoltage state and preventing the failure of the circuit.

### Fourth Embodiment

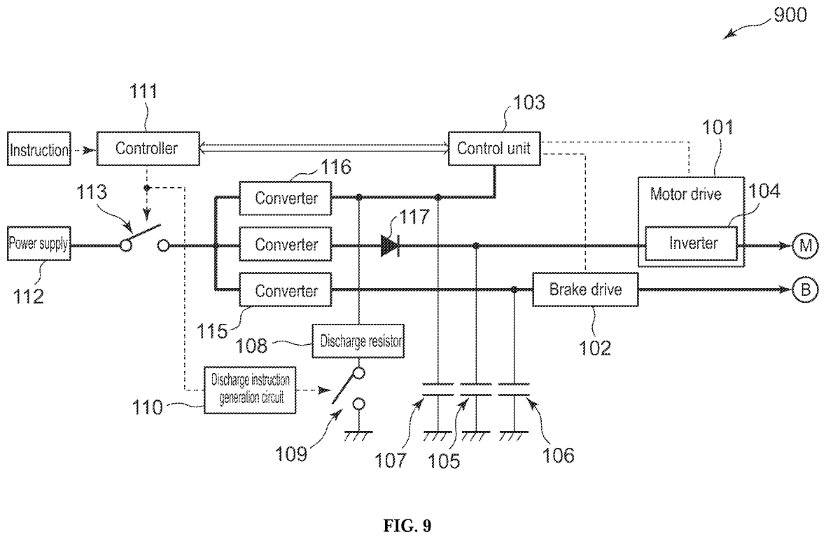

FIG. 9 is a block diagram showing a configuration of a brake circuit discharge system 900 according to a fourth embodiment of the present invention. FIG. 9 illustrates a simplified circuit configuration in each block of the brake circuit discharge system 900. In FIG. 9, only the blocks relating to the present embodiment are shown, and other blocks in each system are omitted for simplicity and ease of description. The present embodiment is different from the first embodiment in that the discharge resistor 108 is connected in parallel with the control unit capacitor 107 to the output of the control unit converter 116 instead of the brake drive circuit converter 115.

Here, a signal that is sent from the control unit 103 to the brake drive circuit 102 is set to apply the brake B when the control unit 103 stops due to power shortage. Specifically, the brake B may be released when the signal is at a high level, and more preferably, a signal line for transmitting the signal may be pulled down. Alternatively, the control unit 103 and the brake drive circuit 102 may be connected through communication in form of signals, and the brake B may be applied if a brake release signal is not sent in a certain cycle.

In such a configuration, even when the control unit 103 enters runaway or breaks down, the power supply to the control unit converter 116 is cut off by the power cut-off switch 113, and the electric charge accumulated in the control unit capacitor 107 is discharged by the discharge resistor 108. Accordingly, when the control unit 103 is stopped due to power shortage, the brake B is applied, and therefore malfunctioning of the actuator can be prevented.

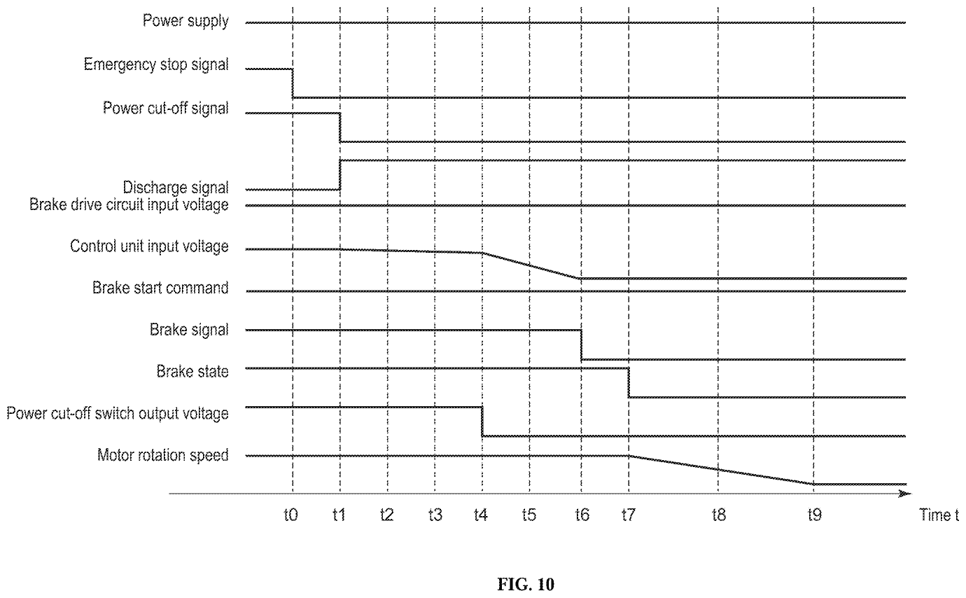

Next, FIG. 10 shows a state at each point after time t0 from the generation of the emergency stop signal in a state where the control unit 103 of the present embodiment has failed. FIG. 10 is a graph showing how the brake circuit discharge system according to the fourth embodiment of the present invention operates at the time of emergency stop.

First, an emergency stop signal is generated at time t0. Then, at time t1, the controller 111, which has received the emergency stop signal, sends a power cut-off signal to the power cut-off switch 113, a discharge signal to the discharge instruction generation circuit 110, and a brake start command to the control unit 103.

At time t1, the discharge instruction generation circuit 110, which has received the discharge signal 108, closes the discharge changeover switch 109 so that a current flows through the discharge resistor 108. Then, the control unit input voltage starts to drop. However, because power is supplied from the control unit converter 116, this voltage drop is gentle.

Next, at time t2, the control unit 103, which has received the brake start command, is supposed to send a brake signal to the brake drive circuit 102 to apply the brake B, but the brake signal is not sent because the control unit fails

That is to say, at time t3, because the brake drive circuit 102 receives no brake signal, the brake release state continues, the brake B is not applied, and the motor M does not decelerate.

On the other hand, at time t4, the power cut-off switch 113, which has received the power cut-off signal, cuts off the power supply to the converters 114 to 116. Then, the power supply from the control unit converter 115, which supplies the energy consumed by the discharge resistor 108, is stopped, and therefore the electric charge accumulated in the control unit capacitor 107 is consumed by the discharge resistor 108. As a result, the input voltage of the control unit 103 starts to drop rapidly.

However, because the input voltage of the brake drive circuit 102 does not drop even at time t5, the brake release state is maintained.

Furthermore, at time t6, the electric charge of the control unit capacitor 107 is discharged completely, the input voltage of the control unit 103 becomes zero, and the control unit 103 stops. Because the control unit 103 is stopped due to power shortage, as described above, a signal of a command to apply the brake B is transmitted from the control unit 103 to the brake drive circuit 102.

Then, at time t7, the brake release is cancelled, and the motor M starts to decelerate.

Finally, at time t9 after time t8, the rotational speed of the motor M becomes zero, and the actuator is completely stopped.

As described above, when the brake circuit discharge system 900 according to the present embodiment is compared with the brake circuit discharge system 100 according to the first embodiment, the rotation of the motor M can be suppressed by the voltage drop of the drive circuit input voltage. Therefore, the brake circuit discharge system 900 can apply the brake B faster than the brake circuit discharge system 100. In addition, the brake circuit discharge system 900 can effect a quick and reliable stop even when the control unit 103 has failed and becomes uncontrollable. Therefore, it is possible to prevent a malfunction caused by the control unit 103 sending an erroneous signal.

### Fifth Embodiment

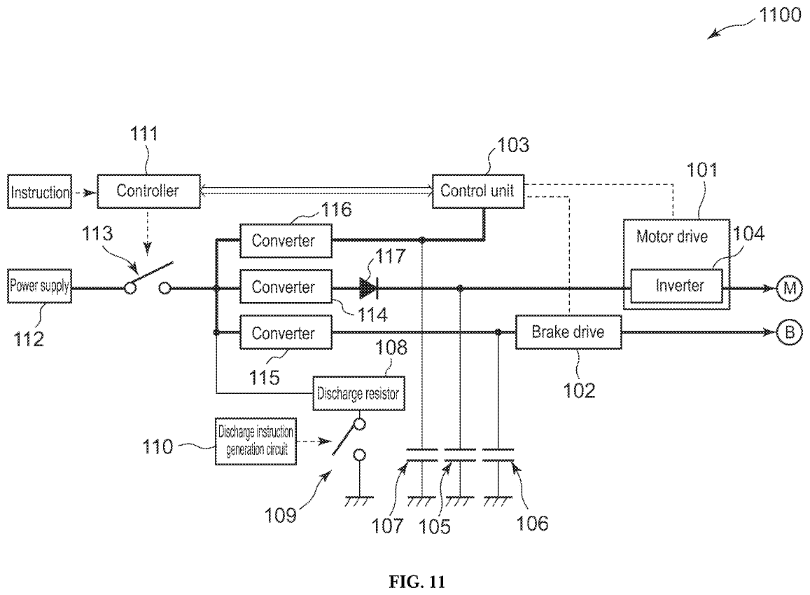

FIG. 11 is a block diagram showing a configuration of a brake circuit discharge system 1100 according to a fifth embodiment of the present invention. FIG. 11 illustrates a simplified circuit configuration in each block of the brake circuit discharge system 1100. In FIG. 11, only the blocks relating to the present embodiment are shown, and other blocks in each system are omitted for simplicity and ease of description. The present embodiment is different from the first embodiment in that the discharge resistor 108 is connected to the input stages of the converters 114 to 116.

With the configuration of the brake circuit discharge system 1100 according to the present embodiment, it is possible to simultaneously stop the rotation and control of the actuator by simultaneously discharging the electric charge accumulated in the capacitors included in the converters 114 to 116 of the motor drive circuit 101, the brake drive circuit 102, and the control unit 103. However, in a case where a backflow prevention circuit is included in a circuit in a stage subsequent to the converters 114 to 116, it is necessary to pay attention because the discharging effect of the capacitors 105 to 107 of the motor drive circuit 101, the brake drive circuit 102, and the control unit 103 cannot be obtained.

### Sixth Embodiment

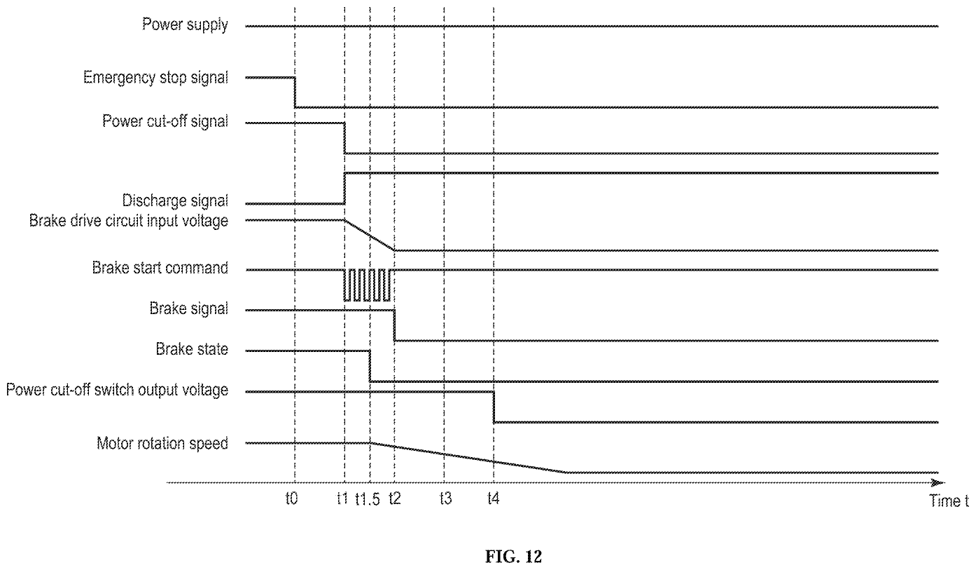

Next, with respect to a sixth embodiment of the present invention, the influence of resistance value of the discharge resistor 108 and the difference between the various delay amounts will be described. The present embodiment is different from the first embodiment in that the resistance value of the discharge resistor 108 is made as small as possible. In the present embodiment, the discharge resistor 108 of 10Ω is used. The brake circuit discharge system according to the present embodiment, which has the same configuration as that of the brake circuit discharge system 100 according to the first embodiment, will be described with reference to FIG. 12 with respect to the state at each point after time t from the generation of the emergency stop signal, in the case of a normal state in which none of the components has failed. FIG. 12 is a graph showing how the brake circuit discharge system according to the present embodiment operates at the time of emergency stop.

First, an emergency stop signal is generated at time t0. Then, at time t1, the controller 111, which has received the emergency stop signal, sends a power cut-off signal to the power cut-off switch 113, a discharge signal to the discharge instruction generation circuit 110, and a brake start command to the control unit 103. At this time, the discharge instruction generation circuit 110, which has received the discharge signal, closes the discharge changeover switch 109 so that a current flows through the discharge resistor 108. Then, the input voltage of the brake drive circuit 102 starts to drop. However, because the resistance value of the discharge resistor 108 is made as small as possible, a current that is close to a current that flows in the case where the power line and the GND are short-circuited flows. Accordingly, although power is supplied from the brake drive circuit converter 115, the amount of the power supply is insufficient, and therefore the voltage drops rapidly.

At time t1.5, the input voltage of the brake drive circuit 102 drops to such an extent that the brake release state cannot be maintained. Accordingly, the brake release state is cancelled, the brake B is applied, and the motor M starts to decelerate.

In the brake circuit discharge system 100 according to the first embodiment, the control unit 103 receives a brake start command at time t2, and the brake B is applied at time t3. On the other hand, in the brake circuit discharge system according to the present embodiment, the brake B can be applied before the control unit 103 has received a brake start command.

### INDUSTRIAL APPLICABILITY

The present invention relates to a brake circuit discharge system including a brake drive circuit, and has industrial applicability.

### INDEX TO THE REFERENCE NUMERALS

100, 400, 600, 800, 900, 1100: Brake circuit discharge system
101, 401: Motor drive circuit
102, 402: Brake drive circuit
103, 403: Control unit
104, 404: Inverter
105 to 107, 405 to 407: Capacitor
108: Discharge resistor
109: Discharge changeover switch
110: Discharge instruction generation circuit
111, 411: Controller
112, 412: Power supply
113, 413: Power cut-off switch
114 to 116, 414 to 416: Converter
117, 417: Diode portion
601, 801: NOT circuit
802: Overvoltage detection circuit
803: OR circuit
810: Actuator
811: Driver
812: Control panel
M: Motor
B: Brake

### INDEX TO DRAWINGS

### FIG. 1

Instruction
101 Motor drive
102 Brake drive
103 Control unit
104 Inverter
108 Discharge resistor
110 Discharge instruction generation circuit
111 Controller
112 Power supply
114, 115, 116 Converter

### FIGS. 2, 3

Power supply
Emergency stop signal
Power cut-off signal
Discharge signal
Brake drive circuit input voltage
Brake start command
Brake signal
Brake state
Power cut-off switch output voltage
Motor rotation speed
Time

### FIG. 4

Instruction
401 Motor drive
402 Brake drive
103 Control unit
404 Inverter
411 Controller
412 Power supply
414, 415, 416 Converter

### FIG. 5

Power supply
Emergency stop signal
Power cut-off signal
Brake drive circuit input voltage
Brake start command
Brake signal
Brake state
Power cut-off switch output voltage
Motor rotation speed
Time

### FIG. 6

Instruction
101 Motor drive
102 Brake drive
103 Control unit
104 Inverter
108 Discharge resistor
111 Controller
112 Power supply
114, 116 Converter
601 NOT circuit

### FIGS. 7

Power supply
Emergency stop signal
Power cut-off signal
Discharge signal
Drive circuit input voltage
Brake start command
Brake signal
Brake state
Power cut-off switch output voltage
Motor rotation speed
Time

### FIG. 8

Instruction
101 Motor drive
102 Brake drive
103 Control unit
104 Inverter
108 Discharge resistor
111 Controller
112 Power supply
114, 116 Converter
801 NOT circuit
802 Overvoltage detection circuit
803 OR circuit
810 Actuator
811 Driver
812 Control panel

### FIG. 9

Instruction
101 Motor drive
102 Brake drive
103 Control unit
104 Inverter
108 Discharge resistor
110 Discharge instruction generation circuit
111 Controller
112 Power supply
115, 116 Converter

### FIG. 10

Power supply
Emergency stop signal
Power cut-off signal
Discharge instruction
Brake drive circuit input voltage
Control unit input voltage
Brake start command
Brake signal
Brake state
Power cut-off switch output voltage
Motor rotation speed
Time

### FIG. 11

Instruction
101 Motor drive
102 Brake drive
103 Control unit
104 Inverter
108 Discharge resistor
110 Discharge instruction generation circuit
111 Controller
112 Power supply
114, 115, 116 Converter

### FIG. 12

Power supply
Emergency stop signal
Power cut-off signal
Discharge signal
Brake drive circuit input voltage
Brake start command
Brake signal
Brake state
Power cut-off switch output voltage
Motor rotation speed
Time

1. A brake circuit discharge system, comprising:
a motor drive circuit configured to drive a motor;
a brake drive circuit configured to drive a brake to decelerate and stop the driving of the motor, and apply the brake at a time of power cut off;
a control unit configured to control operation of the motor drive circuit and the brake drive circuit, and continuously send a brake release signal to the brake drive circuit;
a capacitor connected to at least one of: a power line of the brake drive circuit or a power line of the control unit;
a discharge resistor connected to the power line to which the capacitor is connected and configured to discharge electric charge accumulated in the capacitor;
a discharge changeover switch that is connected in series to the discharge resistor; and
a discharge instruction generation circuit that is connected to the discharge changeover switch, and configured to generate a switching instruction signal for opening and closing the discharge changeover switch.

2. The brake circuit discharge system according to claim 1, wherein:
the capacitor is a brake drive circuit capacitor that is connected to the power line of the brake drive circuit, and
the discharge resistor is connected to the power line of the brake drive circuit in parallel with the brake drive circuit capacitor.

3. The brake circuit discharge system according to claim 1, wherein:
the capacitor is a control unit capacitor that is connected to the power line of the control unit, and
the discharge resistor is connected to the power line of the control unit in parallel with the control unit capacitor.

4. The brake circuit discharge system according to claim 1, wherein the discharge instruction generation circuit is a NOT circuit.

5. The brake circuit discharge system according to claim 4, wherein:
the discharge instruction generation circuit includes an overvoltage detection circuit that is connected between the power line to which the capacitor is connected and the discharge resistor, and an OR circuit that is connected to the overvoltage detection circuit and the NOT circuit, and
the OR circuit is configured to output a logical sum of an output signal of the overvoltage detection circuit and the switching instruction signal to the discharge changeover switch.

6. The brake circuit discharge system according to claim 1, further comprising:
a motor drive circuit converter that is connected in series to a power line of the motor drive circuit, a brake drive circuit converter that is connected in series to the power line of the brake drive circuit, and a control unit converter that is connected in series to the power line of the control unit,
wherein the discharge resistor is connected to input stages of the motor drive circuit converter, the brake drive circuit converter, and the control unit converter.

7. The brake circuit discharge system according to claim 1, wherein a resistance value of the discharge resistor is 1Ω or more and 1,000Ω or less.

8. The brake circuit discharge system according to claim 1, wherein the motor drive circuit, the brake drive circuit, the control unit, and the capacitor are comprised in a robot.

9. The brake circuit discharge system according to claim 2, wherein the discharge instruction generation circuit is a NOT circuit.

10. The brake circuit discharge system according to claim 2, wherein a resistance value of the discharge resistor is 1Ω or more and 1,000Ω or less.

11. The brake circuit discharge system according to claim 2, wherein the motor drive circuit, the brake drive circuit, the control unit, and the capacitor are comprised in a robot.)

12. The brake circuit discharge system according to claim 3, wherein the discharge instruction generation circuit is a NOT circuit.

13. The brake circuit discharge system according to claim 3, wherein a resistance value of the discharge resistor is 1Ω or more and 1,000Ω or less.

14. The brake circuit discharge system according to claim 3, wherein the motor drive circuit, the brake drive circuit, the control unit, and the capacitor are comprised in a robot.

15. The brake circuit discharge system according to claim 4, wherein a resistance value of the discharge resistor is 1Ω or more and 1,000Ω or less.

16. The brake circuit discharge system according to claim 4, wherein the motor drive circuit, the brake drive circuit, the control unit, and the capacitor are comprised in a robot.

17. The brake circuit discharge system according to claim 5, wherein a resistance value of the discharge resistor is 1Ω or more and 1,000Ω or less.

18. The brake circuit discharge system according to claim 6, wherein the discharge instruction generation circuit is a NOT circuit.

19. The brake circuit discharge system according to claim 6, wherein a resistance value of the discharge resistor is 1Ω or more and 1,000Ω or less.

20. The brake circuit discharge system according to claim 6, wherein the motor drive circuit, the brake drive circuit, the control unit, and the capacitor are comprised in a robot.
